(19) United States
(12) Patent Application Publication
(10) Pub. No.: US 2010/0201578 A1
(43) Pub. Date: Aug. 12, 2010

(54) HALF-LOOP CHIP ANTENNA AND ASSOCIATED METHODS

(75) Inventor: Francis Eugene Parsche, Palm Bay, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 12/369,975

(22) Filed: Feb. 12, 2009

(51) Int. Cl. H01Q 1/38; H01P 11/00; H01Q 7/00

(52) U.S. Cl. 343/700 MS; 29/601; 343/866; 343/749

(57) ABSTRACT

The planar or printed chip antenna is configured to enhance the gain relative to its area. The antenna includes a dielectric substrate having first and second opposing sides and a plurality of electrically conductive traces thereon configured to define a half-loop antenna element extending along an arcuate path on a first side of the dielectric substrate and having spaced apart first and second ends. First and second base strips are electrically connected together and aligned on the respective first and second opposing sides of the dielectric substrate adjacent the spaced apart first and second ends of the half-loop antenna element. A feed strip is on the second side of the dielectric substrate and aligned with the first end of the half-loop antenna element and electrically connected thereto. At least one capacitive element is associated with the half-loop antenna element.

### FIELD OF THE INVENTION

The present invention relates to the field of communications, and, more particularly, to antennas and related methods.

### BACKGROUNDS OF THE INVENTION

Newer designs and manufacturing techniques have driven electronic components to small dimensions and miniaturized many communication devices and systems. Unfortunately, antennas have not been reduced in size at a comparative level and often are one of the larger components used in a smaller communications device.

Although antenna size may be reduced by miniaturizing wavelength by increased frequency, lower frequencies can be advantaged for wave propagation, increased receive aperture, beamwidth, or simply for reason of allocation. In the present art and at room temperature, antenna gain is limited at small size by the loss resistance of metal conductors. Even slot type antennas, whose radiation resistance may approach infinity at vanishing small size, are limited by conductor loss through proximity effect. Thus, it can be desirable to reduce antenna size without reducing frequency, but difficult to design and manufacture a reduced size antenna having the greatest gain for the smallest area.

In current, everyday communications devices, many different types of structures are used as antennas, including loaded whips, copper springs (coils and pancakes) and they are used in a variety of different ways. “Patch” antennas may utilize printed circuit board (PCB) construction for ease of manufacture, and “chip” antennas may be components mounted on PWBs.

Antennas may be divided into two families, loops and dipoles, corresponding to the curl and divergence of electric current. The canonical antennas are the circle and line embodiments of the loop and dipole, respectively. Antenna hybrids between the loop and dipole may include the spiral and helix. Euclidian geometries, commonly known, have advantages such as the shortest distance between two points (line), greatest area for perimeter (circle), and they may be preferential antenna shapes for lower conductor loss, greater radiation resistance, increased directivity, etc.

Loop antennas may have special utility for electrically small antenna requirements as they can be loaded to resonance with capacitors rather than inductors. Presently, the antenna designer is afforded better insulators than conductors at room temperature, so capacitors can have lower loss than inductors. Thus, the loop antenna includes the necessary inductor in antenna structure at the most efficient size. Loop antennas may also be advantaged for body worn applications, with magnetic radial near fields that do not cause dielectric heating, or for reduced electromagnetic interference (EMI) pickup at low frequencies.

For portable communications such cellular telephones, the antenna may be located near a metallic chassis or battery, in which case “ground plane” operation may be beneficial. An example of a ground plane antenna is the monopole or “whip” for portable radios, where the whip and radio chassis may together form an antenna system. Although the whip antenna may be better known, the image plane form of the loop antenna can comprise a conductive arch or “half loop”. Half loop antennas share the advantages of loop antennas while permitting ground plane operation.

Examples of prior art antennas include U.S. Pat. No. 6,252,561 to Wu, et al. which is directed to a wireless LAN antenna with a dielectric substrate having a first surface and a second surface. The first surface of the dielectric substrate has a rectangular loop. A rectangular grounding copper foil is adhered within the rectangular loop. A signal feeding copper foil is further included. One end of the signal feeding copper foil is connected to the rectangular loop and the grounding copper foil, while another end of the signal feeding copper foil running across another end of the rectangular loop. Moreover, a layer of back surface copper foil is plated to the back side of the printed circuit board. This back surface copper foil covers one half of the loop on the front surface. Adjustment of the transversal dimensions of the grounding copper foil will impedance-match the antenna to the feeding structure of the antenna.

Also, U.S. Pat. No. 6,590,541 to Schultze is directed to a half-loop antenna having an antenna half-loop positioned on top of a ground plane, the antenna half-loop forming an area whose outer edge forms a convex closed curve. The conductor half-loop has the form of an ellipse tapering to a point at its ends, and at the feed-in point of the conductor half-loop an inductance can be inserted, formed as a spring.

However, none of these approaches is focused on providing a chip antenna component, e.g. for circuit boards or ground planes, while reducing the antenna size and providing the desired gain for a small area.

### SUMMARY OF THE INVENTION

In view of the foregoing background, it is therefore an object of the present invention to provide a radiating planar or printed chip antenna that is configured to enhance the gain relative to its area.

This and other objects, features, and advantages in accordance with the present invention are provided by an antenna including a dielectric substrate having first and second opposing sides and a plurality of electrically conductive traces thereon configured to define a half-loop antenna element extending along an arcuate path on a first side of the dielectric substrate and having spaced apart first and second ends. First and second base strips are electrically connected together and aligned on the respective first and second opposing sides of the dielectric substrate adjacent the spaced apart first and second ends of the half-loop antenna element, and a feed strip is on the second side of the dielectric substrate and aligned with the first end of the half-loop antenna element and electrically connected thereto. At least one capacitive element is associated with the half-loop antenna element.

At least one first conductive via may electrically connect the first and second base strips, and at least one second conductive via may electrically connect the feed strip and the first end of the half-loop antenna element. Adjacent portions of the feed strip and the second base strip may define at least one gap therebetween on the second side of the dielectric substrate. Also, the dielectric substrate may comprise a planar dielectric substrate. The at least one capacitive element may include first and second capacitive elements respectively coupled between the first base strip and the first and second ends of the half-loop antenna element.

In some embodiments, the plurality of electrically conductive traces may be further configured to define an outer antenna coupling element extending along a second arcuate path spaced apart from and surrounding the half-loop antenna element on the first side of the dielectric substrate and having spaced apart first and second ends electrically connected to the first base strip. The at least one capacitive element may comprise a capacitive element positioned at a central portion of the outer antenna coupling element. The second end of the half-loop antenna element may be electrically connected to the first base strip on the first side of the dielectric substrate.

In yet further embodiments, the plurality of electrically conductive traces may be further configured to define inner and outer antenna coupling elements extending along a second arcuate path spaced apart from and surrounding the half-loop antenna element on the first side of the dielectric substrate and each having spaced apart first and second end. The first end of the inner antenna coupling element and the second end of the outer antenna coupling element may be electrically connected to the first base strip adjacent opposite ends thereof. The inner and outer antenna coupling elements may define the at least one capacitive element.

This small and efficient chip antenna design can be used in many different wireless products, including radio frequency communications including common consumer electronic applications, such as cell phones, pagers, wide local area network cards, GSM/land mobile communications, TV antennas, and high frequency radio systems. The antenna works with or without adjacent metal planes, “ground planes”, etc.

A method aspect is directed to making an antenna including forming a plurality of electrically conductive traces on first and second opposing sides of a dielectric substrate to define a half-loop antenna element extending along an arcuate path on a first side of said dielectric substrate and having spaced apart first and second ends. First and second base strips are electrically connected together and aligned on the respective first and second opposing sides of the dielectric substrate adjacent the spaced apart first and second ends of the half-loop antenna element. A feed strip is on the second side of the dielectric substrate and aligned with the first end of the half-loop antenna element and electrically connected thereto. The method includes defining at least one capacitive element associated with the half-loop antenna element.

The method may further include electrically connecting the first and second base strips with at least one first conductive via, and electrically connecting the feed strip and the first end of the half-loop antenna element with at least one second conductive via. Adjacent portions of the feed strip and the second base strip may define at least one gap therebetween on the second side of the dielectric substrate.

Defining the at least one capacitive element may include respectively coupling first and second capacitive elements between the first base strip and each of the first and second ends of the half-loop antenna element. Also, forming the plurality of electrically conductive traces includes defining an outer antenna coupling element extending along a second arcuate path spaced apart from and surrounding the half-loop antenna element on the first side of the dielectric substrate and having spaced apart first and second ends electrically connected to the first base strip.

Defining the at least one capacitive element may include positioning a capacitive element at a central portion of the outer antenna coupling element. Forming the plurality of electrically conductive traces may include electrically connecting the second end of the half-loop antenna element to the first base strip on the first side of the dielectric substrate.

The plurality of electrically conductive traces may be further configured to define inner and outer antenna coupling elements extending along a second arcuate path spaced apart from and surrounding said half-loop antenna element on the first side of the dielectric substrate and each having spaced apart first and second ends, the first end of the inner antenna coupling element and the second end of the outer antenna coupling element being electrically connected to the first base strip adjacent opposite ends thereof. The inner and outer antenna coupling elements may define the at least one capacitive element.

### BRIEF DESCRIPTION OF THE DRAWINGS

FIG. 1 is a top plan view of a first embodiment of an antenna in accordance with the present invention.

FIG. 2 is a bottom plan view of the embodiment of FIG. 1.

FIG. 3 is a schematic diagram of a corresponding circuit of the embodiment of FIG. 1.

FIG. 4 is a top plan view of another embodiment of an antenna in accordance with the present invention.

FIG. 5 is a bottom plan view of the embodiment of FIG. 4.

FIG. 6 is a schematic diagram of a corresponding circuit of the embodiment of FIG. 4.

FIG. 7 is a top plan view of another embodiment of an antenna in accordance with the present invention.

FIG. 8 is a bottom plan view of the embodiment of FIG. 7. FIG. 9 is a schematic diagram of a corresponding circuit of the embodiment of FIG. 7.

FIG. 10 is a diagram depicting the embodiment in FIG. 4 of the present invention in the radiation pattern coordinate system.

FIG. 11 is a plot of the measured XY cut radiation pattern of the embodiment in FIG. 4 of the present invention.

FIG. 12 is a plot of the measured YZ cut radiation pattern of the embodiment in FIG. 4 of the present invention.

FIG. 13 is a graph illustrating the approximate diameter versus gain for the antenna in the embodiment of FIG. 4.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout to indicate similar elements in alternative embodiments.

The present invention is directed to a thin patch antenna or chip antenna that has a desired gain for a small area, such as can be used as a wireless local area network (WLAN) antenna in a personal computer or personal digital assistant (PDA) or chip antenna for personal communication devices. The various embodiments of the antenna can also be used in security, tracking or identification tags, cell phones and any other device that requires a small printed antenna. The antenna can be considered as an inductor-type antenna with a planar shape. The antenna elements may be arcuate or semi-circular in geometry to obtain the optimal gain at a reduced or minimum size. The invention may provide a method for constructing a compound design antenna, which includes a matching transformer, balun, loading capacitor and radiating elements from one or more arcuate elements.

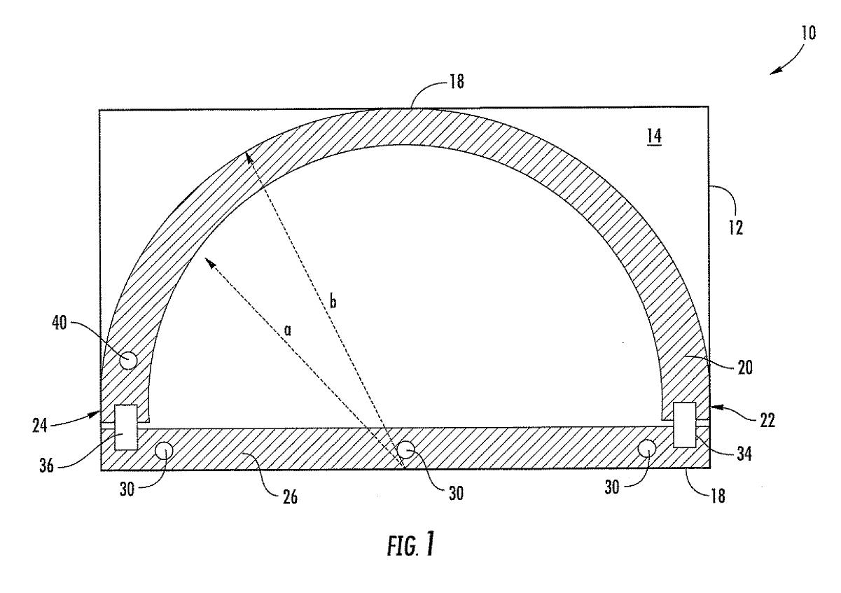

Referring initially to FIGS. 1-3, a first embodiment of an antenna 10 according to the present invention will be described, which may utilize a single arcuate element. The antenna 10 includes a dielectric substrate 12 having first and second opposing sides 14, 16 and a plurality of electrically conductive traces 18 thereon. The traces 18 are configured to define a half-loop antenna element 20 extending along an arcuate path on the first side 14 of the dielectric substrate 12 and having spaced apart first and second ends 22, 24. Half-loop antenna element 20 may be electrically small, e.g. 0.02 to 0.2 wavelengths in circumference at the operating frequency.

First and second base strips 26, 28 are electrically connected together, e.g. through conductive vias 30, and aligned on the respective first and second opposing sides 14, 16 of the dielectric substrate 12 adjacent the spaced apart first and second ends 22, 24 of the half-loop antenna element 20. A feed strip 32 is on the second side 16 of the dielectric substrate 12 and aligned with the first end 24 of the half-loop antenna element 20 and electrically connected thereto by driving point via 40.

In the illustrated embodiment, a pair of capacitive elements 34, 36 are associated with the half-loop antenna element 20. The capacitive elements 34, 36 or tuning features operate to force/tune the electrically conductive half-loop antenna element 20 to resonance. Each of the capacitive elements 34, 36 may be a discrete passive device, such as a trimmer capacitor, or may also be a printed capacitor or gap, in the electrically conductive half-loop antenna element 20, with capacitive coupling. Such a gap would be relatively small to impart the desired capacitance and establish the desired resonance as would be appreciated by the skilled artisan. Illustratively, the capacitive elements 34, 36 are respectively coupled between the first base strip 26 and the first and second ends 22, 24 of the half-loop antenna element 20. In other embodiments, one or more than two capacitive elements may be used.

A plurality of first conductive vias 30 electrically connect the first and second base strips 26, 28, and one second conductive via 40 electrically connects the feed strip 32 and the first end 24 of the half-loop antenna element 20. The conductive vias 30, 40 may be plated holes and extend through the dielectric substrate 12 from respective electrically conductive traces 18 defining the first and second base strips 26, 28, the feed strip 32 and the half-loop antenna element 20. Of course, other similar connectors may be used.

Adjacent portions of the feed strip 32 and the second base strip 28 illustratively define a gap 42 therebetween on the second side 16 of the dielectric substrate 12. Also, the dielectric substrate 12 illustratively comprises a planar dielectric substrate.

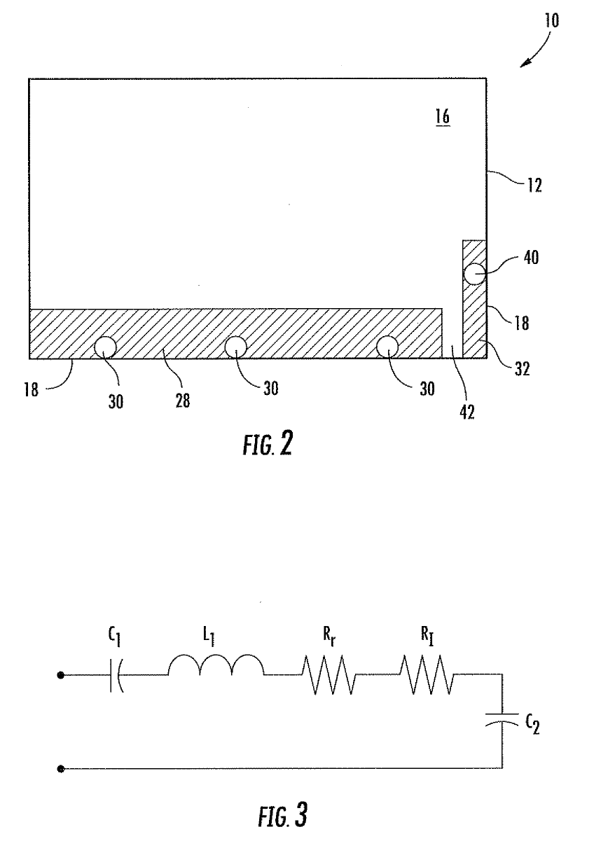

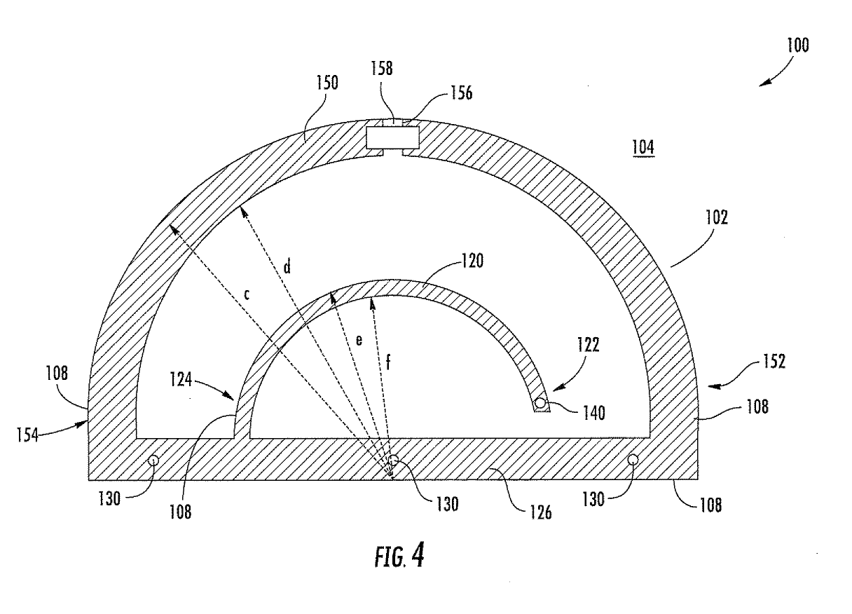

A theory of operation for the single arcuate element FIG. 1 embodiment will now be described. FIG. 3 is a schematic diagram of a circuit equivalent model 50 corresponding to the embodiment of the antenna 10 of FIGS. 1 and 2. Referring thereto, capacitive element 36 corresponds to C2 and capacitive element 34 corresponds to capacitor C1. Preferably, half loop antenna element 20 is electrically small relative to the wavelength, e.g. below natural resonance, and will exhibit a low radiation resistance and an inductive driving point reactance, e.g. Z=0.2+j100 ohms. Capacitors 34, 36 are configured to provide an impedance match to e.g., 50 Ohms, as would be appreciated by those skilled in the art.

The short electrical length of half loop antenna element 20 allows the C₁, C₂ combination to be approximated as a capacitor L network with C1 in series and C₂ in parallel at the driving point. The resonance formula F=1/2π√L₁Cₜₒₜₐₗ may be used to calculate the operating frequency, where L₁ is the inductance of half loop antenna element 20, and Cₜₒₜₐₗ is the net capacitance provided C₁, C₂ (capacitive elements 34, 36) in series according to the series capacitance formula Cₜₒₜₐₗ=1/[(1/C₁)+(1/C₂)]. The resistance obtained varies with ratio of C₁/C₂. As is familiar to those skilled in the art, a Smith Chart may also be used to calculate the value of C₁, C₂.

Referring again to FIG. 3, Rᵣ represents the radiation resistance of loop antenna element 20 and R₁ the conductor loss resistance. Antenna efficiency may be estimated by η=Rᵣ/Rᵣ+R₁), as in practice the losses in capacitors C₁, C₂ may be small and negligible. Antenna gain may then be approximated by G=10 log₁₀ 1.5η=10 log₁₀[(1.5Rᵣ)/(Rᵣ+R₁)] dBi, where η=efficiency, as the directivity of small loop antennas is about 1.5 and gain is the product of directivity D and efficiency η. Operation against large ground planes or a radio chassis may of course affect the realized gain. An infinite ground plane may result in a 3 dB increase in directivity and gain, and smaller size ground planes generally lesser amounts.

The embodiment of FIG. 1 of the present invention is for dual control tuning in that frequency adjustment requires rematching and changing the values of both C₁ and C₂. Referring to FIG. 1, best efficiency and gain have been obtained in prototypes when a=0.78b. This is because conductor resistance losses become excessive when the conductive trace of half loop antenna element 20 is too narrow, and conductor proximity effect losses occur when 20 is too wide. Conductor proximity effect may be appreciated by those skilled in the art with respect to coil inductors, which require spacings between turns for greatest efficiency and Q.

Referring now to FIGS. 4-6, another embodiment of an antenna 100 will now be described, which may use two arcuate elements, which may be preferential for single control tuning over a broad bandwidth. The antenna 100 includes a dielectric substrate 102 having first and second opposing sides 104, 106 and a plurality of electrically conductive traces 108 thereon. The traces 108 are configured to define a half-loop coupling element 120 extending along an arcuate path on the first side 104 of the dielectric substrate 102 and having spaced apart first and second ends 122, 124.

First and second base strips 126, 128 are electrically connected together, e.g. through conductive vias 130, and aligned on the respective first and second opposing sides 104, 106 of the dielectric substrate 102 adjacent the spaced apart first and second ends 122, 124 of the half-loop antenna element 120. A feed strip 132 is on the second side 106 of the dielectric substrate 102 and aligned with the first end 124 of the half-loop coupling element 120 and electrically connected thereto, e.g. through a conductive via 140. Feed strip 132 may be connected to an external transmission (not shown) at its distal end, such as a microstrip trace or coaxial feed, as would be appreciated by those skilled in the art.

The plurality of electrically conductive traces 108 are further configured to define an outer antenna radiating element 150 extending along a second arcuate path spaced apart from and surrounding the half-loop coupling element 120 on the first side 104 of the dielectric substrate 102 and having spaced apart first and second ends 152, 154 electrically connected to the first base strip 126. Antenna radiating element 150 is preferentially electrically small, e.g. 0.02 and 0.20 wavelengths along its circumference at the operating frequency. A capacitive element 156 is positioned at a central portion of the outer antenna radiating element 150, e.g. across a gap 158 therein. Capacitive element 156 may be a fixed capacitor, a mechanical variable capacitor, or a Varactor diode. The second end 124 of the half-loop antenna coupling 120 is electrically connected to the first base strip 126 on the first side 104 of the dielectric substrate 102.

In this embodiment, the half-loop antenna coupling element 120 defines an inner magnetically coupled feed ring and acts as a broadband coupler and is non-resonant. The outer antenna radiating element 150 is resonant and radiates during operation of the antenna 100. Half-loop antenna coupling element 120 is nonresonant and radiating. A balun function for the reduction of feedline common mode currents may also be provided by the half-loop antenna coupling element 120. This effect is akin to an isolation transformer, which would be appreciated by the skilled artisan from low frequency practices.

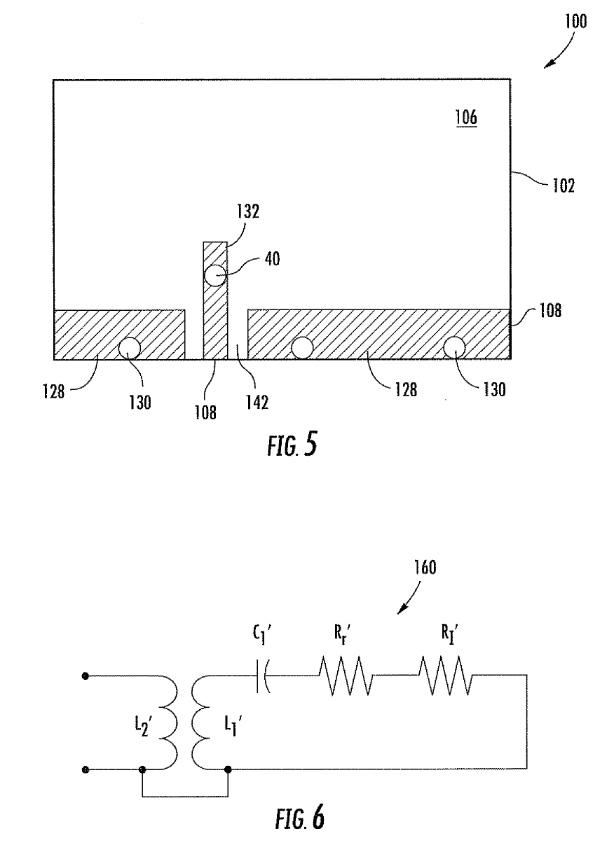

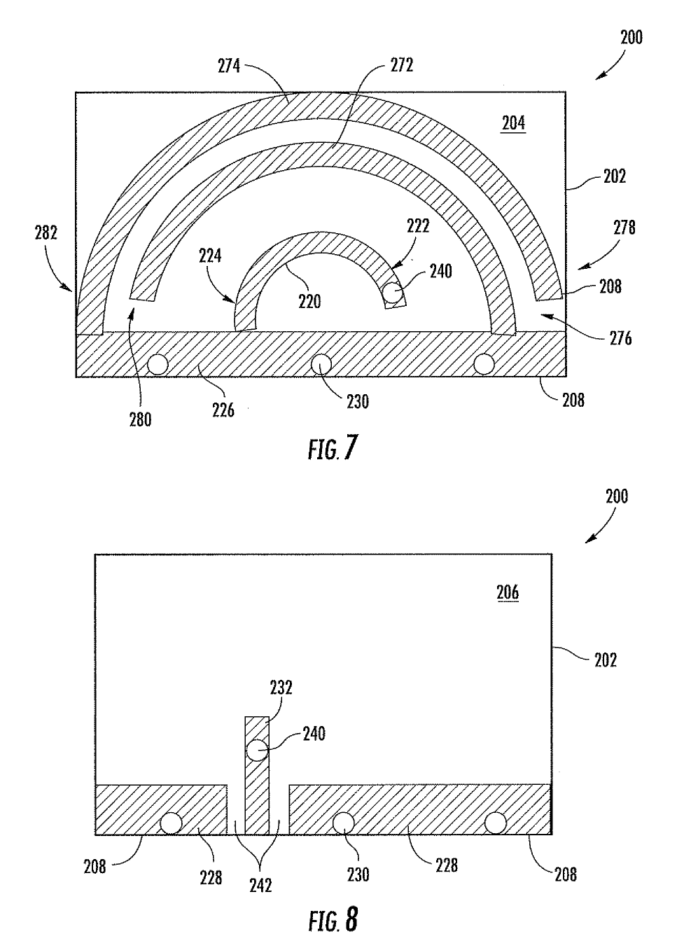

FIG. 6 is a schematic diagram of a corresponding circuit 160 of the two arcuate element embodiment of the antenna 100 of FIGS. 4 and 5, for which a theory of operation will now be described. Referring to FIG. 4, outer antenna radiating element 150 is electrically small, inductive, and forced to resonance by capacitive element 156. It radiates as an electrically small loop antenna (or a half loop antenna if a ground plane is employed). Due the electrically small size, radiation resistance of the outer antenna radiating element 150 may be low for most purposes, e.g. between about 0.01 and 0.3 ohms in practice. Half loop coupling element 120 is therefore included to function as a broadband coupler for antenna radiating element 150, to refer the low radiation resistance to a higher value, such as 50 ohms. Outer antenna radiating element 150 and half loop coupling element 120 couple due to their overlapping apertures and common radial magnetic near fields, e.g. half loop coupling element 120 is akin to a transformer primary “winding” and antenna radiating element 150 is a transformer secondary “winding”.

50 ohms or other desired driving resistances are readily achieved in practice by variation in size of half loop coupling element 120 relative antenna radiating element 150. As transformers are broadband in nature, antenna 100 thus provides broadband single control tuning and tuning ranges of 10 to 1 have been accomplished in practice with the present approach, with VSWR under 2 to 1, simply by the variation of the value of capacitive element 156. The tuning range (AF) is the square root of the capacitance variation (ΔC) at capacitive element 156, e.g. ΔF=√(ΔC), which arises from the common resonance formula F=1/2π√LC. Metal conductor losses in half loop coupling element 120 are small in most practice, as it may operate at a relatively high circuit impedance of say, 50 ohms.

Continuing to refer to FIG. 4, in prototypes the trace width providing the best radiation efficiency and gain performance from outer antenna radiating element 150 may be when d=0.78c. The radius dimensions of half loop coupling element to obtain a 50 ohm driving impedance is e=0.35c and f=0.31c. The trace width of half loop coupling element 120 is preferentially rather narrow to avoid “shading” the near fields of antenna radiating element 150 and reducing radiation resistance.

Table 1 provides the operating parameters of a prototype and example of the FIGS. 4 and 5 embodiment of the present invention:

TABLE 1
Example Of Prototype 2 Element Antenna

| Parameter | Value and Units |
|---|---|
| Type | Electrically Small Half Loop Antenna, |
| | Of Compound Design |
| Antenna Size | 0.063 × 0.670 × 1.33 Inches |
| | (0.004λ × 0.045λ × 0.090λ) |
| Antenna Shape | Planar |
| Antenna Operating | Attached To Metallized Printed Wiring |
| Environment | Board (Radio Transceiver) Measuring |
| | 3.4 × 1.6 inches (0.24λ × 0.10λ) |
| # Of Arctuate | 2 |
| Elements | |
| Construction | Printed Wiring Board, G10 Fiberglass, |
| | ½ Ounce Copper, Single Sided |
| Resonating | 0.9 pf, Ceramic Chip Type |
| Capacitor | |
| (Capacitive | |
| Element 156) | |
| Frequency Of | 796 MHz |
| Operation | |
| Gain | −0.3 dBi, Measured |
| Instantaneous 3 dB | 7.5 MHz (0.9%) Measured |
| Gain Bandwidth | |
| VSWR In 50 Ω | 1.2 to 1 Measured |
| System | |
| Instantaneous 2:1 | 4.5 MHz (0.55%) Measured |
| VSWR Bandwidth | |
| Passband Shape | Quadratic |
| Radiation Pattern | Omnidirectional In Antenna Plane. |
| Shape | Cos² (θ + 90°) Two Petal Rose Cross |
| | Plane. |
| Polarization | Linear |
| Radiation | About 0.23 Ohms, Calculated |
| Resistance (Outer | |
| Element 150) | |
| Conductor Loss | About 0.19 Ohms, Calculated |
| Resistance (Outer | |
| Element 150) | |
| Tunable Bandwidth | About 10 to 1, Single Control |
| Tuning Method | Adjustment Of Value Of Resonating |
| | Capacitor (Capacitive Element 156) |

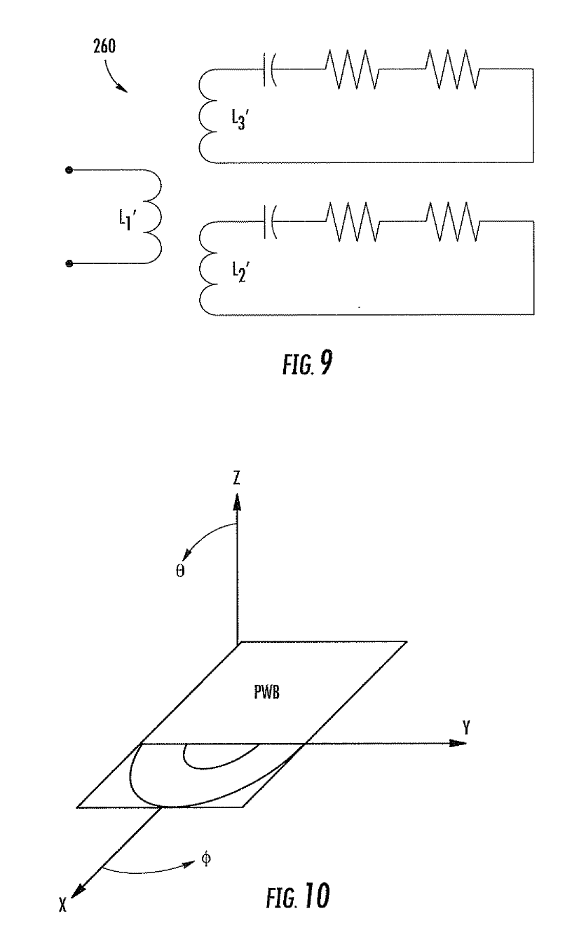

Referring now to FIGS. 7-9, another embodiment of an antenna 200 will now be described, which may use 3 or more arcuate elements, and which allows operation without discrete component capacitors. Embodiment 200 is therefore very thin and planar, and may be about 0.003 inches (7.6×10⁻⁵ meters) thick in practice. The antenna 200 includes a dielectric substrate 202 having first and second opposing sides 204, 206 and a plurality of electrically conductive traces 208 thereon. The traces 208 are configured to define a half-loop antenna element 220 extending along an arcuate path on the first side 204 of the dielectric substrate 202 and having spaced apart first and second ends 222, 224.

First and second base strips 226, 228 are electrically connected together, e.g. through the conductive vias 230, and aligned on the respective first and second opposing sides 204, 206 of the dielectric substrate 202 adjacent the spaced apart first and second ends 222, 224 of the half-loop antenna element 220. A feed strip 232 is on the second side 206 of the dielectric substrate 202 and aligned with the first end 224 of the half-loop antenna element 220 and electrically connected thereto, e.g. through another conductive via 240.

The plurality of electrically conductive traces 208 are further configured to define inner and outer antenna coupling elements 272, 274 extending along a second arcuate path spaced apart from and surrounding the half-loop antenna element 220 on the first side 204 of the dielectric substrate 202 and each having spaced apart first and second ends 276, 278, 280, 282. The first end 276 of the inner antenna coupling element 272 and the second end 282 of the outer antenna coupling element 274 are electrically connected to the first base strip 226 adjacent opposite ends thereof.

Together, the inner and outer antenna coupling elements 272, 274 define a capacitive element, e.g. both elements act as capacitor plates to each other which forces the combined electrically small antenna structure to resonance. Both inner and outer antenna coupling elements 272, 274 radiate in phase at the same time, effectively forming a single electrically small half loop antenna. The distributed capacitance between the inner and outer antenna coupling elements 272, 274 may also stabilize tuning relative adjacent dielectrics, people, structures, etc. as will be appreciated by those skilled in the art. Furthermore, additional antenna coupling elements could be added to reduce antenna size or lower frequency of operation as desired.

FIG. 9 is a schematic diagram of a corresponding circuit 260 of the embodiment of the antenna 200 of FIGS. 7 and 8. Referring to these figures, the theory of operation of the 3 arcuate element embodiment is similar to the 2 element FIG. 4 embodiment, except that the discrete chip capacitor (capacitive element 156) is omitted and replaced by outer antenna coupling element 274. The distributed capacitance between inner and outer antenna coupling elements 272, 274 forms capacitive element 156 in situ. Numerical electromagnetic software models have been used to predict and scale the frequency of operation for this embodiment, such as Ansoft High Frequency Structure Simulator (HFSS), by Ansoft Corporation, Pittsburg, Pa. The Momentum planar EM structure simulator by Agilent Labs, Santa Clara, Calif. may also be used. Meshing density considerations may make efficiency prediction problematic in small antennas, and for this parameter circuit equivalent calculations may be preferred.

Once a PWB pattern/antenna design is established for antenna 200, the entire PWB artwork for the antenna may be scaled linearly, e.g. resized overall, to accomplish designs for other frequencies. As antenna size is the reciprocal of frequency, doubling the size of antenna 200 drops the frequency by ½, all other parameters held constant. Fine tuning to frequency may be accomplished by ablation of portions of inner and outer antenna coupling elements 272, 274, especially at the free ends. Inner and outer antenna coupling elements 272, 274 have been closely spaced in prototypes for maximum loading effect, and with large numbers of arcuate elements an interdigitated loading capacitor is effectively formed in situ. Low loss PWB materials such as polytetrafluoroethylene (PTFE) or liquid crystal polymer (LCP) may be preferred for three or more arctuate element embodiments. The single and multiple arcuate element embodiments of the present invention are advantaged for use on lossy PWB materials. Copper is generally the preferred material for inner and outer antenna coupling elements 272, 274: although silver is the best room temperature conductor, the gain benefit over copper is negligible in practice. Any connections in the resonant radiating arctuate elements should be well soldered. In electrically small embodiments Δη=√(Δσ), e.g. the radiation efficiency changes with the square root of conductor conductivity.

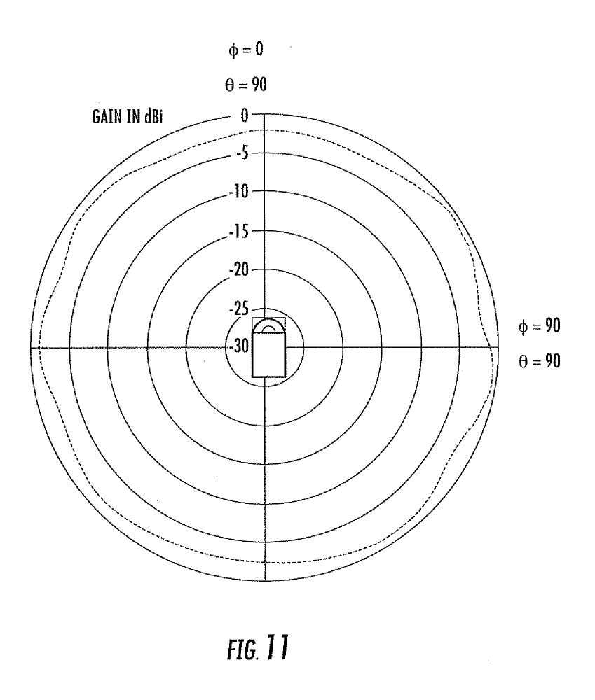

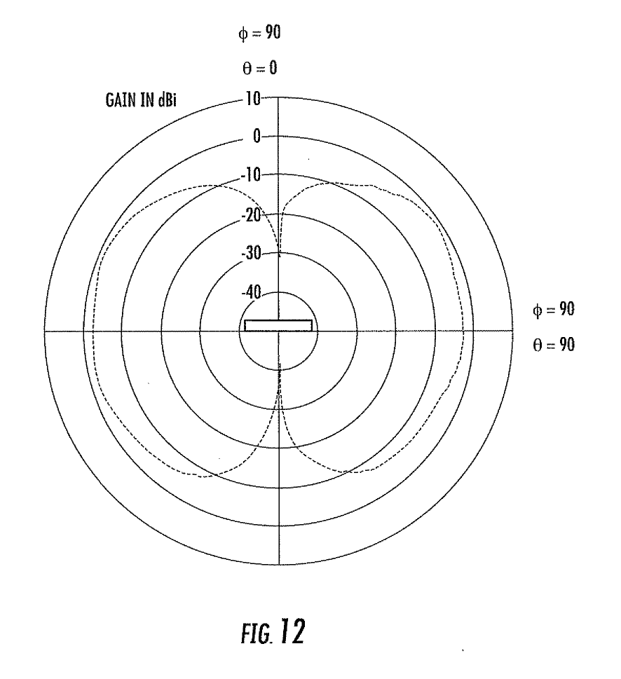

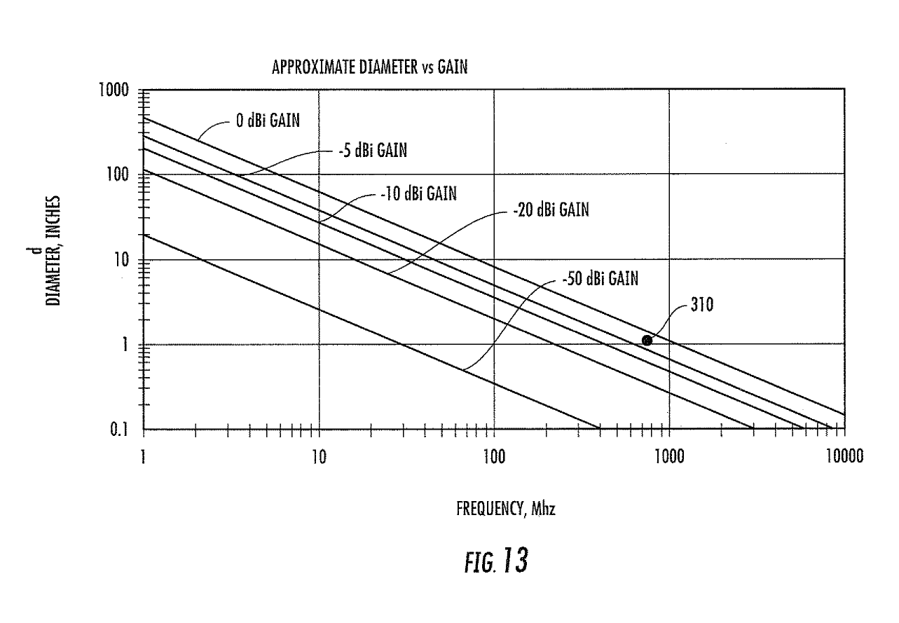

Radiation patterns for the present invention will now be considered. FIG. 10 depicts the FIG. 4 (two arcuate element) embodiment of the present invention in the Institute Of Electrical and Electronics Engineers Standard 145-1973 radiation pattern coordinate system. FIG. 11 is a polar plot of the measured XY cut radiation pattern of the FIG. 4 example and prototype of the present invention. FIG. 12 is a polar plot of the measured YZ cut radiation pattern of the FIG. 4 example and prototype of the present invention. Both the radiation patterns are for the E_{φ} field component and the gain units are in dBi or decibels with respect to the hypothetical isotropic antenna.

As can be appreciated, the XY plane pattern is approximately circular and omnidirectional, and the YZ plane pattern shape is approximately cos²(φ+90°), e.g. a two petal rose. The ZX plane radiation pattern (not shown) was similarly cos² (θ+90°) shaped, e.g. a two petal rose. Thus, shapes of the examples of the present invention radiation patterns are similar to a small dipole, and they may be sufficient for many purposes. The polarization of the present invention was substantially linear and E_{φ}, e.g. the electric field of the radiated plane wave lies substantially in the φ orientations of the FIG. 10 coordinate system. Although the radiation pattern measurements are of the FIG. 4 (two element) embodiment, the radiation pattern shapes for other embodiments (single arcuate element, three arcuate element etc.) are the same or nearly so.

In addition to providing good gain for size, the present invention has the advantage that it may be implemented at almost any combination of size and frequency with a gain trade. FIG. 13 is a chart of the gain trade of the present invention at different sizes and frequencies, as an approximation. The size parameter is antenna outer diameter in inches, e.g. the diameter of the imaginary circle on which the outer arcuate radiating element lies, and referring to FIG. 1 antenna outer diameter d is equal twice the b dimension (d=2b). The −50 dBi trade may be useful for low frequency receive only requirements, where ambient noise levels are high. The gain trade at the smallest sizes arises from the room temperature conductor resistance of copper, which is a fundamental limitation for small antennas as mentioned previously.

The present invention is of course directed towards electrically small antenna requirements overall, where small size may be preferential to positive gain values. Realized gains will vary slightly above and below the FIG. 13 values with ground planes or free space environment, PWB materials, conductor plating, capacitor Q, etc. The gain of the present invention asymptotically approaches 1.7 dBi at the largest sizes. Continuing to refer to FIG. 13, point 310 represents the measured gain of the Table 1 example and prototype in relation to size and frequency.

This small and efficient chip antenna design, e.g. as set forth in the described embodiments, can be used in many different wireless products, including radio frequency communications including common consumer electronic applications, such as cell phones, pagers, wide local area network cards, GSM/land mobile communications, TV antennas, and high frequency radio systems. The antenna works with or without adjacent metal planes, “aground planes”, etc.

A method aspect will be described while referring to the previously described embodiments of FIGS. 1-9. The method is directed to making an antenna 10, 100, 200 including forming a plurality of electrically conductive traces 18, 108, 208 on first and second opposing sides 14/16, 104/106, 204/206 of a dielectric substrate 12, 102, 202 to define a half-loop antenna element 20, 120, 220 extending along an arcuate path on a first side of the dielectric substrate and having spaced apart first and second ends 22/24, 122/124, 222/224.

First and second base strips 26/28, 126/128, 226/228 are electrically connected together and aligned on the respective first and second opposing sides of the dielectric substrate adjacent the spaced apart first and second ends of the half-loop antenna element 20, 120, 220. A feed strip 32, 132, 232 is on the second side of the dielectric substrate and aligned with the first end of the half-loop antenna element and electrically connected thereto. The method includes defining at least one capacitive element 34/36, 156, 272/274 associated with the half-loop antenna element 20, 120, 220.

The method may further include electrically connecting the first and second base strips with at least one first conductive via 30, 130, 230, and electrically connecting the feed strip and the first end of the half-loop antenna element with at least one second conductive via 40, 140, 240. Adjacent portions of the feed strip and the second base strip may define at least one gap 42, 142, 242 therebetween on the second side of the dielectric substrate.

Defining the at least one capacitive element may include respectively coupling first and second capacitive elements 34, 36 between the first base strip 26 and each of the first and second ends 22, 24 of the half-loop antenna element 20 (e.g. as shown in FIG. 1). Also, forming the plurality of electrically conductive traces may include defining an outer antenna radiating element 150 extending along a second arcuate path spaced apart from and surrounding the half-loop antenna element 120 on the first side 104 of the dielectric substrate 102 and having spaced apart first and second ends 122, 124 electrically connected to the first base strip 126 (e.g. as shown in FIG. 4).

Defining the at least one capacitive element may include positioning a capacitive element 156 at a central portion or gap 158 of the outer antenna radiating element 150. Forming the plurality of electrically conductive traces 108 may include electrically connecting the second end 124 of the half-loop antenna element 120 to the first base strip 126 on the first side 104 of the dielectric substrate 102.

The plurality of electrically conductive traces 208 may be further configured to define inner and outer antenna coupling elements 272, 274 extending along a second arcuate path spaced apart from and surrounding the half-loop antenna element 220 on the first side 204 of the dielectric substrate 202 and each having spaced apart first and second ends 276/280, 278/282. The first end 276 of the inner antenna coupling element 272 and the second end 282 of the outer antenna coupling element 274 being electrically connected to the first base strip 226 adjacent opposite ends thereof. As discussed above, the inner and outer antenna coupling elements 272, 274 define a capacitive element.

Loop antennas such as the present invention can be advantaged over dipoles as their radial near field is magnetic rather than electric. Eddy current heating loss from magnetic fields are constant with frequency, and may be less pronounced than dielectric heating loss, which rises with the square of frequency. The present invention may therefore be preferential for body worn or handheld requirements. In prototype testing, the tuning stability of the present invention was much better than planar inverted F (PIFA) slot types when handled. This is attributed to the radial magnetic, rather than radial electric, near fields of the present invention.

In summary, the present invention provides a half loop antenna of compound design, in which a radiating element, loading capacitor, matching coupler, and balun are realized from a system of arcuate or half circle elements. The invention is small, provides good gain for size, is scalable, is operable with and without a ground plane, and is suitable for portable communications requirements such as cell phones or pagers.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An antenna comprising:
a dielectric substrate having first and second opposing sides and a plurality of electrically conductive traces thereon configured to define
a half-loop antenna element extending along an arcuate path on a first side of said dielectric substrate and having spaced apart first and second ends,
first and second base strips electrically connected together and aligned on the respective first and second opposing sides of the dielectric substrate adjacent the spaced apart first and second ends of the half-loop antenna element, and
a feed strip on the second side of said dielectric substrate and aligned with the first end of the half-loop antenna element and electrically connected thereto; and
at least one capacitive element associated with the half-loop antenna element.

2. The antenna according to claim 1 further comprising:
at least one first conductive via electrically connecting the first and second base strips; and
at least one second conductive via electrically connecting the feed strip and the first end of the half-loop antenna element.

3. The antenna according to claim 1 wherein adjacent portions of the feed strip and the second base strip define at least one gap therebetween on the second side of said dielectric substrate.

4. The antenna according to claim 1 wherein the dielectric substrate comprises a planar dielectric substrate.

5. The antenna according to claim 1 wherein the at least one capacitive element comprises first and second capacitive elements respectively coupled between the first base strip and the first and second ends of the half-loop antenna element.

6. The antenna according to claim 1 wherein the plurality of electrically conductive traces are further configured to define an outer antenna coupling element extending along a second arcuate path spaced apart from and surrounding said half-loop antenna element on the first side of said dielectric substrate and having spaced apart first and second ends electrically connected to said first base strip.

7. The antenna according to claim 6 wherein said at least one capacitive element comprises a capacitive element positioned at a central portion of said outer antenna coupling element.

8. The antenna according to claim 6 wherein the second end of said half-loop antenna element is electrically connected to said first base strip on the first side of said dielectric substrate

9. The antenna according to claim 1 wherein the plurality of electrically conductive traces are further configured to define inner and outer antenna coupling elements extending along a second arcuate path spaced apart from and surrounding said half-loop antenna element on the first side of said dielectric substrate and each having spaced apart first and second ends, the first end of the inner antenna coupling element and the second end of the outer antenna coupling element being electrically connected to said first base strip adjacent opposite ends thereof; the inner and outer antenna coupling elements defining the at least one capacitive element.

10. An antenna comprising:
a planar dielectric substrate having first and second opposing sides and a plurality of electrically conductive traces thereon configured to define
a half-loop antenna element extending along an arcuate path on a first side of said planar dielectric substrate and having spaced apart first and second ends,
first and second base strips and aligned on the respective first and second opposing sides of the planar dielectric substrate adjacent the spaced apart first and second ends of the half-loop antenna element, and
a feed strip on the second side of said planar dielectric substrate and aligned with the first end of the half-loop antenna element;
at least one capacitive element associated with the half-loop antenna element;
a plurality of base strip conductive vias electrically connecting the first and second base strips; and
at least one feed strip conductive via electrically connecting the feed strip and the first end of the half-loop antenna element.

11. The antenna according to claim 10 wherein the at least one capacitive element comprises first and second capacitive elements respectively coupled between the first base strip and the first and second ends of the half-loop antenna element.

12. The antenna according to claim 10 wherein the plurality of electrically conductive traces are further configured to define an outer antenna coupling element extending along a second arcuate path spaced apart from and surrounding said half-loop antenna element on the first side of said dielectric substrate and having spaced apart first and second ends electrically connected to said first base strip.

13. The antenna according to claim 12 wherein said at least one capacitive element comprises a capacitive element positioned at a central portion of said outer antenna coupling element.

14. The antenna according to claim 12 wherein the second end of said half-loop antenna element is electrically connected to said first base strip on the first side of said dielectric substrate

15. The antenna according to claim 10 wherein the plurality of electrically conductive traces are further configured to define inner and outer antenna coupling elements extending along a second arcuate path spaced apart from and surrounding said half-loop antenna element on the first side of said dielectric substrate and each having spaced apart first and second ends, the first end of the inner antenna coupling element and the second end of the outer antenna coupling element being electrically connected to said first base strip adjacent opposite ends thereof; the inner and outer antenna coupling elements defining the at least one capacitive element.

16. A method of making an antenna comprising:
forming a plurality of electrically conductive traces on first and second opposing sides of a dielectric substrate to define
a half-loop antenna element extending along an arcuate path on a first side of said dielectric substrate and having spaced apart first and second ends,
first and second base strips electrically connected together and aligned on the respective first and second opposing sides of the dielectric substrate adjacent the spaced apart first and second ends of the half-loop antenna element, and
a feed strip on the second side of said dielectric substrate and aligned with the first end of the half-loop antenna element and electrically connected thereto; and
defining at least one capacitive element associated with the half-loop antenna element.

17. The method according to claim 16 further comprising:
electrically connecting the first and second base strips with at least one first conductive via; and
electrically connecting the feed strip and the first end of the half-loop antenna element with at least one second conductive via.

18. The method according to claim 16 wherein adjacent portions of the feed strip and the second base strip define at least one gap therebetween on the second side of said dielectric substrate.

19. The method according to claim 16 wherein defining the at least one capacitive element comprises respectively coupling first and second capacitive elements between the first base strip and each of the first and second ends of the half-loop antenna element.

20. The method according to claim 16 wherein forming the plurality of electrically conductive traces includes defining an outer antenna coupling element extending along a second arcuate path spaced apart from and surrounding said half-loop antenna element on the first side of said dielectric substrate and having spaced apart first and second ends electrically connected to said first base strip.

21. The method according to claim 20 wherein defining the at least one capacitive element comprises positioning a capacitive element at a central portion of said outer antenna coupling element.

22. The method according to claim 20 wherein forming the plurality of electrically conductive traces includes electrically connecting the second end of said half-loop antenna element to said first base strip on the first side of said dielectric substrate.

23. The method according to claim 16 wherein the plurality of electrically conductive traces are further configured to define inner and outer antenna coupling elements extending along a second arcuate path spaced apart from and surrounding said half-loop antenna element on the first side of said dielectric substrate and each having spaced apart first and second ends, the first end of the inner antenna coupling element and the second end of the outer antenna coupling element being electrically connected to said first base strip adjacent opposite ends thereof; the inner and outer antenna coupling elements defining the at least one capacitive element.
